(19) United States
(12) Patent Application Publication
(10) Pub. No.: US 2018/0091451 A1
(43) Pub. Date: Mar. 29, 2018

(54) CHAT ROOM MANAGEMENT METHOD, CHAT ROOM SYSTEM AND ELECTRONIC DEVICE AND SERVER THEREOF

(71) Applicant: Elite International Education Services, Inc., Taipei City (TW)

(72) Inventors: Xue-Ying Gu, Palo Alto, CA (US); Qing-Wen Cheng, Palo Alto, CA (US); Hsing-Chiang Chiang, Taipei City (TW); Su-Jen Liu, Taipei City (TW); Wei-En Kao, Taipei City (TW); Ting-Kang Tsao, Taipei City (TW)

(73) Assignee: Elite International Education Services, Inc., Taipei City (TW)

(21) Appl. No.: 15/428,152

(22) Filed: Feb. 9, 2017

Related U.S. Application Data
(60) Provisional application No. 62/401,885, filed on Sep. 29, 2016.

(30) Foreign Application Priority Data
Nov. 16, 2016 (TW) 105137462

(51) Int. Cl. H04L 12/58; G06Q 30/02; G06Q 50/00; H04L 29/06; G06F 17/30

(52) U.S. Cl. CPC H04L 51/046; H04L 51/16; G06Q 30/0277; G06K 7/1417; G06Q 50/01; H04L 63/08; G06F 17/30879; G06Q 30/0261

(57) ABSTRACT

The invention provides a chat room management method, a chat room system and an electronic device and a server thereof. The chat room management method includes: establishing a chat group on a chat platform, and establishing multiple sub chat groups in the chat group, wherein the chat group and the sub chat groups of the chat group form a hierarchical chat group structure; recording multiple historical chat records corresponding to the sub chat groups; filtering multiple critical articles from the historical chat records, and sharing the critical articles in the chat group; and logging in to a first sub chat group of the sub chat groups to access the historical chat records of the first sub chat group and the critical articles.

### CROSS REFERENCE TO RELATED APPLICATION

This application claims the priority benefits of U.S. provisional application Ser. No. 62/401,885, filed on Sep. 29, 2016 and Taiwan application serial no. 105137462, filed on Nov. 16, 2016. The entirety of each of the above-mentioned patent applications is hereby incorporated by reference herein and made a part of this specification.

### BACKGROUND OF THE INVENTION

### Field of the Invention

The invention relates to a chat room management method, a chat room system, and an electronic device and a server thereof, and more particularly relates to a chat room management method, a chat room system, and an electronic device and a server thereof having a hierarchical structure.

### Description of Related Art

The currently available chat room software is mainly for chatting only and does not provide a function of data sharing or other subsidiary functions. Thus, new users have no access to the previous discussions and can only find messages that are posted after they join the chat room. For this reason, new users who just joined the chat room may raise questions that have been asked before, and old users of the chat room may feel reluctant to provide answers for they may have replied to similar questions many times before. The new users who do not get the answers they seek may become more likely to quit the chat room. It will result in a vicious circle. Besides, the current group chat room may not be large enough to accommodate a group of thousands of users. Even if there is a group that can accommodate thousands of users, since there are so many ongoing discussions, some articles may be overwhelmed by others instantly before getting any attention, which impairs the efficiency of discussion.

### SUMMARY OF THE INVENTION

In view of the above, the invention provides a chat room management method, a chat room system, and an electronic device and a server thereof, by which contents of discussion are recorded for new users and a hierarchical structure is designed to enhance the efficiency of discussion in a chat room.

The invention provides a chat room management method, including: establishing a chat group on a chat platform and establishing a plurality of sub chat groups in the chat group; recording a plurality of historical chat records corresponding to the sub chat groups, wherein the chat group and the sub chat groups in the chat group form a hierarchical chat group structure; sieving out a plurality of critical articles from the historical chat records and sharing the critical articles in the chat group; and logging in to a first sub chat group of the sub chat groups to access the historical chat record corresponding to the first sub chat group and the critical articles.

In an embodiment of the invention, the step of logging in to the first sub chat group of the sub chat groups includes: scanning a QR code (quick response code) corresponding to the first sub chat group to log in to the first sub chat group, wherein the QR code includes login information corresponding to the first sub chat group.

In an embodiment of the invention, the chat room management method further includes: setting a tag to a first critical article of the critical articles; and granting a login account an access to the first critical article when a user region tag of the login account matches the tag.

In an embodiment of the invention, the chat room management method further includes: placing an advertisement corresponding to the first critical article according to the tag, wherein an advertising rate of the advertisement is determined by one or a combination of a hit rate, an article value, and the user region tag of the first critical article.

The invention provides a chat room system, which includes a server and an electronic device coupled to the server. The electronic device establishes a chat group on a chat platform and establishes a plurality of sub chat groups in the chat group, wherein the chat group and the sub chat groups in the chat group form a hierarchical chat group structure. The server records a plurality of historical chat records corresponding to the sub chat groups. The server sieves out a plurality of critical articles from the historical chat records and shares the critical articles in the chat group. The electronic device logs in to a first sub chat group of the sub chat groups to access the historical chat record corresponding to the first sub chat group and the critical articles.

In an embodiment of the invention, the electronic device scans a QR code (quick response code) corresponding to the first sub chat group to log in to the first sub chat group, wherein the QR code includes login information corresponding to the first sub chat group.

In an embodiment of the invention, the server sets a tag to a first critical article of the critical articles, and a login account is granted an access to the first critical article when a user region tag of the login account matches the tag.

In an embodiment of the invention, the server places an advertisement corresponding to the first critical article according to the tag, wherein an advertising rate of the advertisement is determined by one or a combination of a hit rate, an article value, and the user region tag of the first critical article.

The invention provides an electronic device coupled to a server and adapted to execute a chat room system. The electronic device includes a processor and a memory coupled to the processor. The processor establishes a chat group on a chat platform and establishes a plurality of sub chat groups in the chat group, wherein the chat group and the sub chat groups in the chat group form a hierarchical chat group structure. The server records a plurality of historical chat records corresponding to the sub chat groups. The server sieves out a plurality of critical articles from the historical chat records and shares the critical articles in the chat group. The processor logs in to a first sub chat group of the sub chat groups to access the historical chat record corresponding to the first sub chat group and the critical articles.

The invention provides a server coupled to an electronic device and adapted to execute a chat room system. The server includes a processor and a memory coupled to the processor. The electronic device establishes a chat group on a chat platform and establishes a plurality of sub chat groups in the chat group, wherein the chat group and the sub chat groups in the chat group form a hierarchical chat group structure. The processor records a plurality of historical chat records corresponding to the sub chat groups. The processor sieves out a plurality of critical articles from the historical chat records and shares the critical articles in the chat group. The electronic device logs in to a first sub chat group of the sub chat groups to access the historical chat record corresponding to the first sub chat group and the critical articles.

Based on the above, according to the chat room management method, the chat room system, the electronic device and the server of the invention, the historical chat records are stored in the respective sub chat groups and an important part of the historical chat records is sieved out as the critical articles to be stored in the chat group for access of all the users of the chat group. It solves the problem that new users may raise the same questions repeatedly for they are not able to read previous chat records of other users.

To make the aforementioned and other features and advantages of the invention more comprehensible, several embodiments accompanied with figures are described in detail as follows.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a block diagram of the chat room system according to an embodiment of the invention.

FIG. 2 is a flowchart of the chat room management method according to an embodiment of the invention.

FIG. 3 is a diagram of the chat room system according to an embodiment of the invention.

FIG. 4 is a flowchart of the method of logging in to the sub chat group according to an embodiment of the invention.

FIG. 5 is a flowchart of the method of logging in to the sub chat group according to another embodiment of the invention.

### DESCRIPTION OF THE EMBODIMENTS

FIG. 1 is a block diagram of a chat room system according to an embodiment of the invention.

Referring to FIG. 1, a chat room system 100 of the invention includes a server 110 and an electronic device 120 coupled to the server 110. The electronic device 120 may be a personal computer, a laptop computer, a smart phone, a tablet computer, or any other mobile device. The electronic device 120 may be coupled to the server 110 by wired or wireless communication. The server 110 includes a processor 111 and a memory 112. The electronic device 120 includes a processor 121 and a memory 122. The processor 111 and the processor 121 may respectively be a central processing unit (CPU), a microprocessor, a digital signal processor (DSP), a programmable controller, a microcontroller, an application specific integrated circuit (ASIC), a programmable logic device (PLD), or other similar devices, for example. The memory 112 and the memory 122 may respectively include a volatile memory (e.g., a dynamic random access memory) and a non-volatile memory (e.g., a storage device such as hard disk, solid state drive, or flash memory) for storing data of the server 110 and the electronic device 120 for a long period of time or temporarily.

In the chat room system 100 of the invention, the user may install an application of a chat platform of the invention in the electronic device 120 and, after the installation, enable the application to connect to the server 110, so as to perform functions of chatting online or checking out a critical article. The application installed by the user may differ according to the type of the electronic device 120. For example, if the user uses a smart phone or other types of mobile devices, the user may install a mobile device version of the application. If the user uses a personal computer or a laptop computer, the user may install a personal computer version of the application.

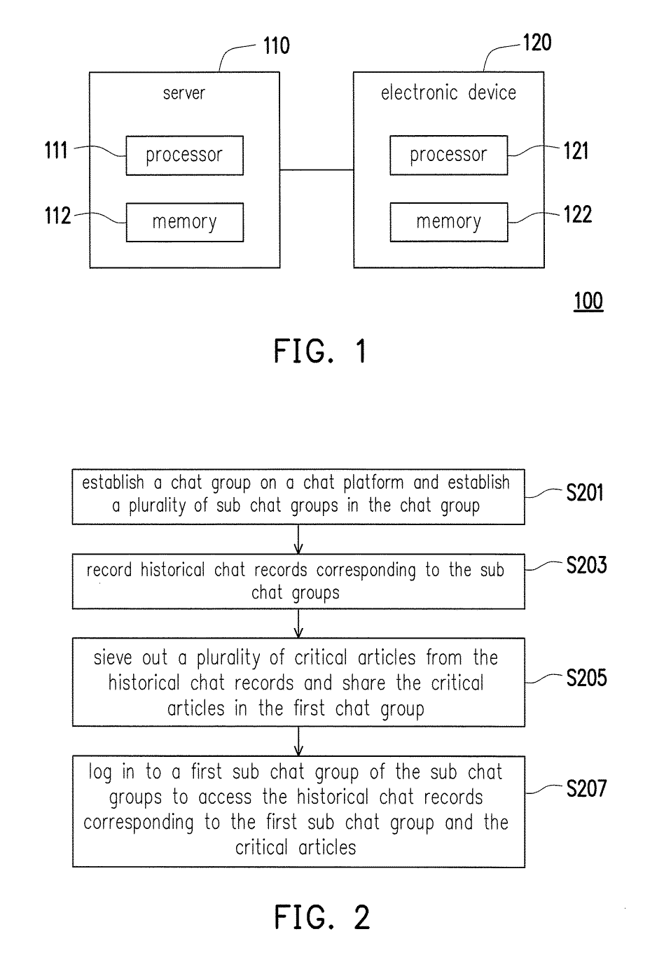

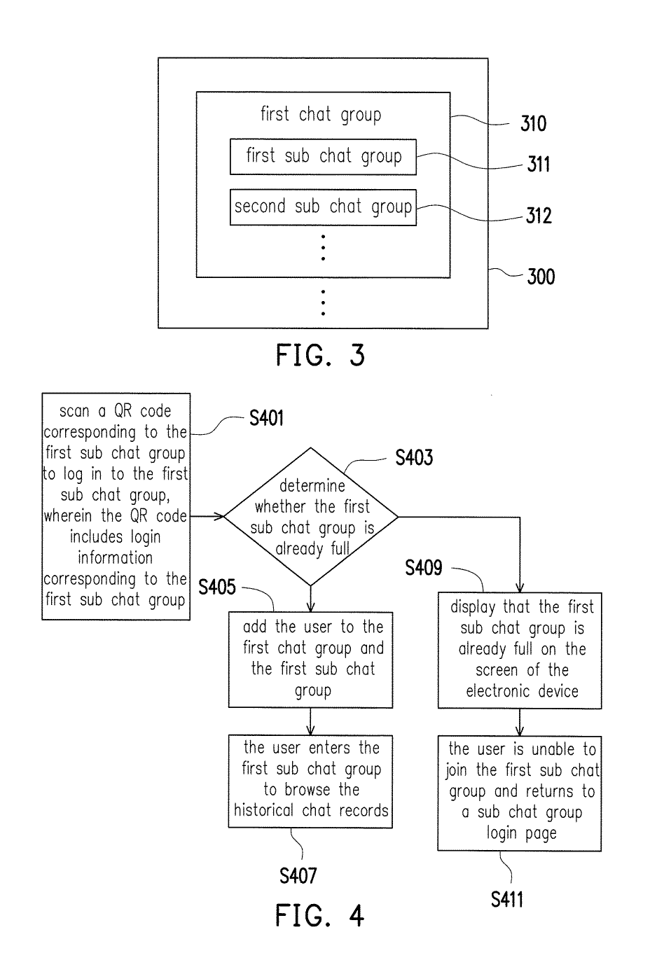

FIG. 2 is a flowchart of a chat room management method according to an embodiment of the invention. FIG. 3 is a diagram of the chat room system according to an embodiment of the invention.

Referring to FIG. 2 and FIG. 3, in Step S201, a chat group is established on a chat platform 300, and a plurality of sub chat groups are established in the chat group, wherein the chat group and the sub chat groups in the chat group form a hierarchical chat group structure. Specifically, all the users who use the chat platform 300 are able to establish the chat group, and the creator of the chat group or the user who has a specific authority in the chat group may choose to set the chat group as an open chat group or a private chat group. All the users on the chat platform 300 are allowed to join the open chat group, but it requires an invitation sent by the user who has the specific authority in the chat group to join the private chat group. For example, when a user, such as a business, an artist, and so on, establishes a chat group, the creator of the chat group may choose to set the chat group as an open chat group for public discussion. When a user of a company or an organization establishes a chat group, the creator of the chat group may choose to set the chat group as a private chat group, so as to prevent leakage of important messages.

In an embodiment, after a first chat group 310 is established, the creator of the first chat group 310 may choose whether to establish a first sub chat group 311 having the same name as the first chat group 310 to be used simply for chatting. Then, users who join the first chat group 310 may establish a second sub chat group 312 or more other sub chat groups by themselves. The creator of the first chat group 310 may be called a city lord of the first chat group 310 and may also be called a village head of the first sub chat group 311. The title, city lord, may be upgraded as the number of the users (referred to as “city friends” hereinafter) of the first chat group 311 increases. For example, if the number of the users of one chat group is 5,000 or less, this chat group may be called a “city” and the creator of this chat group is the aforementioned “city lord.” When the number of the users of one chat group exceeds 5,000, this chat group may be upgraded to a “state” and the creator of this chat group may be upgraded to “state governor.” When the number of the users of one chat group exceeds 10,000, this chat group may be upgraded to a “county” and the creator of this chat group may be upgraded to “county governor.” When the number of the users of one chat group exceeds 20,000, this chat group may be upgraded to a “kingdom” and the creator of this chat group may be upgraded to “king.” If there are more users in one chat group, more titles may be set for this chat group and the creator thereof. The aforementioned upgrade of the chat group may be performed by calculating the number of the users every predetermined time (e.g., a month), so as to adjust the rank of the chat group (in other words, decrease in the user number would lead to downgrade). The number of the users and the title of the chat group may be sent back to the server 110 as variables, so as to facilitate expansion or modification.

The importance of the chats and critical articles in one chat group may change according to the upgrade of the chat group. For example, a weight value of one critical article may be increased as the chat group is upgraded, which is applicable to the charge for advertisements placed in the critical article. Details thereof will be described later.

In Step S203, historical chat records corresponding to the sub chat groups are recorded. Specifically, all the users who join the chat group are able to establish a sub chat group at any time, and the sub chat group is also called a “village.” The creator of the sub chat group is also called “village head.” One user may establish a plurality of villages in one chat group. The village head or the user who has a specific authority in the village may choose to set the village as an open village (open sub chat group) or a private village (private sub chat group). All the users on the chat platform 300 are allowed to join the open village, but it requires an invitation sent by the user (referred to as “village friend” hereinafter) of the private village to join the private village. The maximum number of users of one village may be set to be less than the number of users of one city, which is set to 2,000, for example.

In an embodiment, after a user joins one village, the server 110 records all chat records in the village and sorts the chat records into historical chat records. Therefore, after joining one village, the user may browse all historical chat records that are recorded before the user joins the village. Accordingly, the problem that new users who just join the village may ask repeated questions is suppressed.

In Step S205, a plurality of critical articles are sieved out from the historical chat records and shared in the first chat group 310. Specifically, the village head may collect the chat records of the village and filter out redundant articles in the chat records, so as to sort the chat records into the critical articles to be submitted to the city lord. The city lord may determine a value of the critical article and decide whether to put the critical article in shared data of the city. In an embodiment, the operation of filtering the chat records may include automatically determining the redundant articles according to a dictionary established by the server 110 and deleting the redundant articles, so as to sort the chat records into the critical articles.

In Step S207, the user logs in to the first sub chat group 311 of the sub chat groups to access the historical chat record corresponding to the first sub chat group 311 and the critical articles. Specifically, when the user logs in to one village, the user may browse the historical chat records of all users of the village that are recorded before the user joins the village. The user may also access all the critical articles of the city that includes the village, i.e., all the shared data of the city.

For example, the city lord, a city commissioner (i.e., a good friend designated by the city lord in the city), and a user who has a authority in the city may publish an article or announcement in a shared data area or a specific bulletin area of the city. Each city has a shared data folder category of its own, and only the city lord and the city commissioner are able to set the shared data folder category. Each article or critical article may have multiple layers of categories and may be set with an unlimited number of tags. For example, an article about basketball may be categorized under the multi-layered category of “life”—“sports”—“ball”—“basketball.” The city lord may choose to publish the article to the entire chat platform 300 or limit the article to be browsed only within the city. The city lord may also put articles that other cities publish to the chat platform 300 in the shared data area of the city. The article may accept formats including pictures, text, images, sound, etc., and provide functions such as rating, collection, message, hit rate, and so on. It should be noted that the chat platform 300 may further include a built-in “official” organization for promoting the critical articles of the entire chat platform 300 and cities or villages with a large number of users. The city lord may also put an information excerpt of the “official” organization in the shared data area of the city.

It should be noted that the chat platform 300 may set a tag to a first critical article of the critical articles. A login account is granted an access to the first critical article only when a user region tag of the login account matches the tag. Thereby, the chat platform 300 may set a particular article to be accessible exclusively for users of a certain region.

Moreover, the chat platform 300 may place an advertisement corresponding to the first critical article according to the tag. An advertising rate for the advertisement may be decided by one of a hit rate, an article value, and the user region tag of the first critical article or a combination of the foregoing. For example, the chat platform 300 may place corresponding advertisements according to the user region tag and/or a time tag. The article value for determining the advertising rate may be set by the city lord, or be decided by a total view, a total recommendation, or a total rating.

FIG. 4 is a flowchart of a method of logging in to the sub chat group according to an embodiment of the invention.

In Step S401, a QR code (quick response code) corresponding to the first sub chat group 311 is scanned to log in to the first sub chat group 311, wherein the QR code includes login information corresponding to the first sub chat group 311. Thus, the first sub chat group 311 to be logged in may be learned from the QR code. In an embodiment, the QR code may further include device information (e.g., a device identifier of the mobile device, such as a smart phone or a tablet computer, used by the registrant) of a registrant who wishes to log in to the first sub chat group 311 or identification information such as an e-mail account of the registrant. In addition, the QR code may further include device information (e.g., a device identifier of the mobile device, such as a smart phone or a tablet computer, used by the inviter) of an inviter who invites the registrant to log in to the first sub chat group 311 or identification information such as an e-mail account of the inviter. The inviter may be a user who has already logged in to the first sub chat group 311.

In Step S403, whether the first sub chat group 311 is already full is determined.

If the first sub chat group 311 is not full yet, in Step S405, the server 110 adds the user to the first chat group 310 and the first sub chat group 311.

In Step S407, the user enters the first sub chat group 311 to browse the historical chat records.

If the first sub chat group 311 is already full, in Step S409, the electronic device 120 displays that the first sub chat group 311 is already full on the screen.

In Step S411, the user is unable to join the first sub chat group 311 and returns to a sub chat group login page.

It should be noted that, although the QR code is scanned for the user to join the sub chat group in Step S401, the invention is not limited thereto. In another embodiment, the user may join the first sub chat group 311 by directly clicking on an invitation message sent by the users in the first sub chat group 311. Once the user joins the first sub chat group 311, the user may also browse the shared data of the first chat group 310.

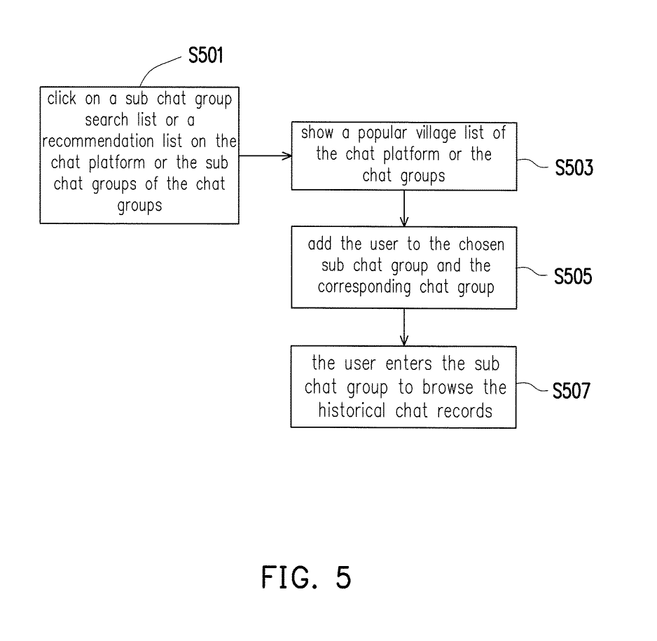

FIG. 5 is a flowchart of the method of logging in to the sub chat group according to another embodiment of the invention.

In Step S501, the user clicks on a sub chat group search list or a recommendation list on the chat platform 300 or the sub chat groups of the chat groups.

In Step S503, a popular village list of the chat platform 300 or the chat groups is shown. That is, a plurality of sub chat groups that have most users on the chat platform 300 or in the chat groups are listed. For example, ten sub chat groups that have most users on the chat platform 300 or in the chat groups are listed.

In Step S505, the server 110 adds the user to the chosen sub chat group and the corresponding chat group.

In Step S507, the user enters the sub chat group to browse the historical chat records.

It should be noted that when the user joins a city, the chat platform 300 may display a list of all open villages in the city for the user to choose to join in. The chat platform 300 may also display all the villages that the user joins in the city.

In an embodiment, data such as announcements and subject information of the chat group may be shared among all the sub chat groups under the chat group. A user number obtained by adding up the users (also referred to as “village friend”) of all the villages of one city may be called a city friend number. Only village friends can open a new village in the city. That is, when a city is established, only the village friends of the only village that has the same name as the city can open a new village. The village friends of the village that has the same name may invite friends to join this village, and the village friend who opens a new village is also called the village head. The village friends of the second and subsequent villages established in one city may invite their friends and village friends of other villages in the same city to join the village.

In an embodiment, the city lord of one city may designate a user who is the city lord's friend and the city friend as the city commissioner to share management works of the city lord. Specifically, the city lord and the city commissioner may organize the chats of the villages and publish the chats to a bulletin board, an essence area, or an activity block of the city, and set a basic description of the city (e.g., local information, shared information of the city, or related important information). The city lord and the city commissioner may also perform city friend management (suspension/resumption, cancellation of addition, and blacklist setting), village chat room management (pause/resume, historical data clearance, expired data search), and activity management (lecture, group buy, and vote). The city lord and the city commissioner may also perform article category management. The city lord and the city commissioner may also perform management over reported city friends or articles. The city lord may designate a user who is the city friend and also the city lord's friend as the village head, and send a notification to this user via the chat platform 300. The city lord may suspend or directly kick out the village head of a certain village in the city, and the city lord may take the place of the village head directly or designate a village friend of the village as the village head.

In an embodiment, the city friend who has a specific authority may publish announcements of the city and may choose a specific village or all the villages of the city to receive the announcements. After a user joins the village or the city, a mark of the city may be displayed only on a chat room list on a home page of the chat platform 300. If the user joins multiple villages in the city, only the mark of the city is displayed, and the number of unread articles is displayed in the unit of one city. For example, the chat platform 300 may display the number of unread articles of one city only without displaying the number of unread articles of each village in the city.

In an embodiment, when a user sees that a certain city has many unread articles from the chat room list on the home page of the chat platform 300, the user may click on this city to enter the chat room list of this city and then click on the village that has the unread articles to read the unread articles.

In conclusion, according to the chat room management method, the chat room system, the electronic device and the server of the invention, the historical chat records are stored in the respective sub chat groups and an important part of the historical chat records is sieved out as the critical articles to be stored in the chat group for access of all the users of the chat group. It solves the problem that new users may raise the same questions repeatedly for they are not able to read previous chat records of other users. In addition, according to the invention, the user may join a specific sub chat group and the chat group including the sub chat group by scanning the QR code corresponding to the sub chat group, so as to expedite user authentication. Further, according to the invention, an advertisement corresponding to the time or location may be placed according to the tag of the article, and the advertisement value may be proportional to the overall value of the article, so as to establish an accurate advertising rate.

It will be apparent to those skilled in the art that various modifications and variations can be made to the disclosed embodiments without departing from the scope or spirit of the invention. In view of the foregoing, it is intended that the invention covers modifications and variations provided that they fall within the scope of the following claims and their equivalents.

What is claimed is:

1. A chat room management method, comprising:
establishing a chat group on a chat platform and establishing a plurality of sub chat groups in the chat group, wherein the chat group and the sub chat groups in the chat group form a hierarchical chat group structure;
recording a plurality of historical chat records corresponding to the sub chat groups;
sieving out a plurality of critical articles from the historical chat records and sharing the critical articles in the chat group; and
logging in to a first sub chat group of the sub chat groups to access the historical chat record corresponding to the first sub chat group and the critical articles.

2. The chat room management method according to claim 1, wherein the step of logging in to the first sub chat group of the sub chat groups comprises:
scanning a QR code (quick response code) corresponding to the first sub chat group to log in to the first sub chat group, wherein the QR code comprises login information corresponding to the first sub chat group.

3. The chat room management method according to claim 1, further comprising:
setting a tag to a first critical article of the critical articles; and
granting a login account an access to the first critical article when a user region tag of the login account matches the tag.

4. The chat room management method according to claim 3, further comprising:
placing an advertisement corresponding to the first critical article according to the tag, wherein an advertising rate of the advertisement is determined by one or a combination of a hit rate, an article value, and the user region tag of the first critical article.

5. A chat room system, comprising:
a server; and
an electronic device coupled to the server,
wherein the electronic device establishes a chat group on a chat platform and establishes a plurality of sub chat groups in the chat group, wherein the chat group and the sub chat groups in the chat group form a hierarchical chat group structure,
wherein the server records a plurality of historical chat records corresponding to the sub chat groups,
wherein the server sieves out a plurality of critical articles from the historical chat records and shares the critical articles in the chat group, and
wherein the electronic device logs in to a first sub chat group of the sub chat groups to access the historical chat record corresponding to the first sub chat group and the critical articles.

6. The chat room system according to claim 5, wherein the electronic device scans a QR code (quick response code) corresponding to the first sub chat group to log in to the first sub chat group, wherein the QR code comprises login information corresponding to the first sub chat group.

7. The chat room system according to claim 5, wherein the server sets a tag to a first critical article of the critical articles, and a login account is granted an access to the first critical article when a user region tag of the login account matches the tag.

8. The chat room system according to claim 7, wherein the server places an advertisement corresponding to the first critical article according to the tag, wherein an advertising rate of the advertisement is determined by one or a combination of a hit rate, an article value, and the user region tag of the first critical article.

9. An electronic device coupled to a server and adapted for a chat room system, the electronic device comprising:
a processor; and
a memory coupled to the processor,
wherein the processor establishes a chat group on a chat platform and establishes a plurality of sub chat groups in the chat group, wherein the chat group and the sub chat groups in the chat group form a hierarchical chat group structure,
wherein the server records a plurality of historical chat records corresponding to the sub chat groups,
wherein the server sieves out a plurality of critical articles from the historical chat records and shares the critical articles in the chat group, and
wherein the processor logs in to a first sub chat group of the sub chat groups to access the historical chat record corresponding to the first sub chat group and the critical articles.

10. A server coupled to an electronic device and adapted to execute a chat room system, the server comprising:
a processor; and
a memory coupled to the processor,
wherein the electronic device establishes a chat group on a chat platform and establishes a plurality of sub chat groups in the chat group, wherein the chat group and the sub chat groups in the chat group form a hierarchical chat group structure,
wherein the processor records a plurality of historical chat records corresponding to the sub chat groups,
wherein the processor sieves out a plurality of critical articles from the historical chat records and shares the critical articles in the chat group, and
wherein the electronic device logs in to a first sub chat group of the sub chat groups to access the historical chat record corresponding to the first sub chat group and the critical articles.
